(19) United States
(12) Patent Application Publication
(10) Pub. No.: US 2026/0182788 A1
(43) Pub. Date: Jul. 2, 2026

(54) WIPES DISPENSING POUCH ASSEMBLY WITH INTEGRAL MEMBRANE AND ZIPPER CLOSURE

(71) Applicant: Illinois Tool Works Inc., Glenview, IL (US)

(72) Inventors: Eric P. Plourde, Frankfort, IL (US); Sebastian Izarra, Naperville, IL (US); Brian Salat, Carol Stream, IL (US); Luke Schweitzer, Carol Stream, IL (US)

(73) Assignee: Illinois Tool Works Inc., Glenview, IL (US)

(21) Appl. No.: 19/391,155

(22) Filed: Nov. 17, 2025

Related U.S. Application Data
(60) Provisional application No. 63/739,707, filed on Dec. 30, 2024.

(51) Int. Cl. A47K 10/32; B31B 70/81; B65D 33/25; B65D 83/08

(52) U.S. Cl. CPC A47K 10/32; B31B 70/8131; B65D 33/2508; B65D 83/0805; A47K 2010/3266

(57) ABSTRACT

A wipes dispensing pouch assembly includes a flexible pouch with opposing first and second interior surfaces configured to retain moistened wipes. A single, unitary piece zipper closure couples with the interior surfaces of the pouch. The zipper closure comprises opposing first and second interlocking profiles that repeatedly mate and separate to seal and open the pouch. A connecting membrane extends between and joins the interlocking profiles, featuring a dispensing aperture for extracting wipes. An elastomeric layer may be applied to or located within the connecting membrane, enhancing the seal and reducing moisture loss. The method for manufacturing the pouch assembly involves extruding the pouch panels and the zipper closure, coupling the zipper closure to the pouch, and cutting the dispensing aperture through the connecting membrane.

### CROSS-REFERENCE TO RELATED APPLICATIONS

This application claims priority to U.S. Provisional Application No. 63/739,707 (filed 30, Dec. 2024), the entire disclosure of which is incorporated herein by reference.

### BACKGROUND

### Technical Field

The subject matter described herein relates to packaging technologies, specifically to flexible pouches for dispensing wipes.

### Discussion of Art

Containers for wipes, such as hand wipes, baby wipes, and disinfectant wipes, typically are dispensed from rigid tubs or flexible packages. The rigid tubs tend to use significantly more plastic to manufacture than flexible packages. The flexible packages may include an adhesive reclose mechanism, but these mechanisms tend to allow the wipes to dry out before all wipes are used.

In the field of wipes dispensing apparatuses, one goal is to maintain the moisture content of the wipes while providing a convenient and efficient dispensing mechanism. This can involve designing containers that reduce material usage, ensure ease of use, and prevent the wipes from prematurely drying out. Existing solutions, such as adhesive patches or rigid fitments, often fail to provide an adequate seal, leading to the drying out of the wipes. Additionally, the use of rigid tubs results in higher material costs and environmental impact due to the increased use of plastic.

Some pouches with a zipper-type closures can incorporate a membrane with an opening for dispensing wipes. This design can reduce material usage compared to rigid tubs and provide a better reclose feature to maintain the moisture in the wipes. The closure and the membrane are separate components, however, which can complicate the manufacturing process and may still allow some moisture to escape through gaps between the closure and the membrane.

Other pouches can have a perforated connecting membrane installed in the mouth of a pouch. The perforated membrane allows powder or granular product to be shaken out of the pouch. This design, however, is not best for dispensing moist wipes as the perforations may not provide an adequate seal to prevent moisture loss.

There is a need for a wipes dispensing pouch apparatus that avoids or addresses the shortcomings described above.

### BRIEF SUMMARY

Certain examples of the subject matter described herein provide a wipes dispensing pouch assembly having a flexible pouch with opposing first and second interior surfaces configured to retain a plurality of moistened wipes between the interior surfaces, and a single, unitary piece zipper closure coupled with the first and second interior surfaces of the flexible pouch. The zipper closure comprises opposing first and second interlocking profiles configured to repeatedly mate with each other and separate from each other to repeatedly seal and open the pouch, and a connecting membrane extending between and joining the first and second interlocking profiles. The connecting membrane has a dispensing aperture through which the wipes are extracted from inside the pouch. The single, unitary piece zipper closure is coupled with the first and second interior surfaces of the pouch with the first interlocking profile extending along the first interior surface, the second interlocking profile extending along the second interior surface, and the connecting membrane extending between the first and second interlocking profiles and between the first and second interior surfaces.

A method for manufacturing a wipes dispensing pouch assembly is also provided. The method comprises extruding one or more panels that form a flexible pouch, the one or more panels extruded to have opposing first and second interior surfaces in the flexible pouch that are shaped to retain a plurality of moistened wipes between the interior surfaces; extruding a single, unitary piece zipper closure having opposing first and second interlocking profiles shaped to repeatedly mate with each other and separate from each other to repeatedly seal and open the pouch, the zipper closure also extruded to have a connecting membrane extending between and joining the first and second interlocking profiles; coupling the zipper closure to the first and second interior surfaces of the one or more panels with the first interlocking profile extending along the first interior surface and the second interlocking profile extending along the second interior surface and the connecting membrane bridging a gap between the first and second interior surfaces; and cutting a dispensing aperture through the connecting membrane through which the wipes are extracted from inside the pouch.

In another example, a wipes dispensing pouch assembly includes a flexible pouch having opposing first and second interior surfaces configured to retain a plurality of moistened wipes between the interior surfaces, a single, unitary piece zipper closure coupled with the first and second interior surfaces of the flexible pouch, the zipper closure comprising first and second interlocking profiles configured to mate with each other to seal the pouch, the zipper closure also including a membrane extending between and joining the first and second interlocking profiles, the membrane having a dispensing aperture through which the wipes are removed from the pouch, and an elastomeric layer applied to or located within the membrane between the first and second interlocking members.

### BRIEF DESCRIPTION OF THE DRAWINGS

The inventive subject matter may be understood from reading the following description of non-limiting embodiments, with reference to the attached drawings, wherein below:

FIG. 1 illustrates one example of a wipes dispensing pouch assembly;

FIG. 2 illustrates one example of a zipper closure shown in FIG. 1;

FIG. 3 illustrates another example of the zipper closure shown in FIG. 1;

FIG. 4 illustrates another example of the zipper closure shown in FIG. 1;

FIG. 5 illustrates another example of the zipper closure shown in FIG. 1; and

FIG. 6 illustrates a flowchart of one example of a method for manufacturing a wipes dispensing pouch assembly.

### DETAILED DESCRIPTION

Containers for wipes, such as hand wipes, baby wipes, and disinfectant wipes, can be dispensed from rigid tubs or flexible packages. Rigid tubs are often made from a significant amount of plastic, which is not environmentally friendly. Flexible packages, on the other hand, usually feature an adhesive reclose mechanism. These adhesive patches tend to lose their effectiveness over time, leading to the drying out of the wipes before they are fully used.

Some existing solutions for dispensing moist wipes provide a pouch with a zipper-type closure that has a membrane connected to the walls of the pouch (and not connected to the zipper assembly). The zipper closure optionally can be referred to as a zipper assembly. While this design reduces material usage compared to rigid tubs and can offer a superior reclose feature to maintain moisture in the wipes, the design still has several shortcomings. The separate sealing process between the pouch walls and the membrane can create points where moisture can escape, leading to the drying out of the wipes. Additionally, the integration of the zipper and membrane as separate components complicates the manufacturing process and increases the potential for leakage.

One or more examples of the wipes dispensing pouch assemblies described herein can address these issues by integrating the zipper closure and the membrane into a single, unitary piece. This design simplifies the manufacturing process and reduces potential leakage points, thereby improving moisture retention. The assembly can include a flexible pouch with opposing first and second interior surfaces that define an interior volume for retaining several moistened wipes. A single, unitary piece zipper closure can be coupled with the first and second interior surfaces of the flexible pouch.

The zipper closure includes opposing first and second interlocking profiles that repeatedly mate with and separate from each other to seal and open the pouch. A connecting membrane extends between and joins the first and second interlocking profiles, featuring a dispensing aperture through which the wipes are extracted from inside the pouch.

The zipper closure can integrate the interlocking profiles with the connecting membrane as a single body formed through a co-extrusion process. This process involves extruding the zipper profiles and the connecting membrane as a single unit. The zipper profiles can be made from low-density polyethylene (LDPE) and form the locking elements. For example, the zipper profiles can be made from a thermoplastic polymer formed from the ethylene monomer, and can have low density (e.g., no more than 0.900 g/cm³ in one example, between 0.910 and 0.940 g/cm³ in another example, and so on). The connecting membrane may be or may incorporate a stretchy elastomeric plastic, and can provide the flexible interface between the zipper halves. Elastomeric polymers can have elastic properties that can stretch significantly under stress and return to an original shape when the stress is removed. Examples of elastomeric plastics that can be incorporated into the membrane or used to form the membrane can include thermoplastic elastomers (TPE), thermoplastic polyurethane (TPU), ethylene-vinyl acetate (EVA), polyolefin elastomers (POE), silicone elastomers, styrene-butadiene-styrene (SBS), or the like. The co-extrusion ensures that the zipper and membrane are seamlessly bonded, creating a unified structure that enhances the overall functionality and moisture retention of the pouch. For example, the zipper and membrane can be a single, unitary body devoid of gaps, adhesives, seams, or the like.

During the manufacturing process, the zipper assembly can be positioned within a mouth of the pouch. The mouth of the pouch refers to the opening or entrance of the flexible pouch (e.g., container or bag) through which the contents (e.g., wipes) can be accessed or dispensed. In the context of a wipes dispensing pouch, the mouth is the part of the pouch where the zipper assembly and membrane are installed, thereby allowing for the controlled removal of wipes while maintaining the moisture and integrity of the remaining contents.

The interior surfaces of the pouch are designed to be bound with the zipper assembly to provide a secure fit that prevents the wipes from drying out. The zipper assembly can be coupled with the interior surfaces of the pouch through several methods to provide this secure and reliable attachment that maintains the integrity and functionality of the pouch. For example, the zipper assembly can be heat-sealed to the interior surfaces of the pouch. This can involve applying heat and pressure to bond the zipper profiles and the connecting membrane to the pouch material. Heat sealing creates a strong and durable bond to securely attach the zipper assembly to the pouch. Ultrasonic welding can be used to direct high-frequency sound waves to generate heat at interfaces between the zipper assembly and the pouch material. The localized heat can melt the material(s) to create a strong bond when the materials cool and solidify. Adhesive bonding can be used by applying a suitable adhesive to the surfaces of the zipper assembly and the pouch material. The adhesive creates a strong bond between the zipper assembly and the interior surfaces of the pouch when the adhesive cures. This may be useful for materials that may be sensitive to heat or when a flexible bond is required. Optionally, the zipper assembly and the pouch material can be co-extruded as a single unit (along with the membrane). This can involve extruding the zipper profiles, connecting membrane, and pouch material simultaneously or concurrently, which provides for seamless integration and a strong bond between the components.

The zipper profiles align or are proximate to the edges of the pouch opening (e.g., the mouth), and the connecting membrane can span the gap between the profiles, thereby closing the mouth of the pouch assembly. This allows the zipper to function effectively while maintaining the integrity of the interior environment of the pouch. The integration of the zipper and membrane into a single unit reduces potential leakage points, which can improve moisture retention by the pouch.

For example, the stretchy elastomeric plastic in or on the membrane that bridges the gap between the zipper profiles (e.g., the mouth) increases the sealing properties of the pouch. When a wipe is pulled through the dispensing aperture cut through or formed through the membrane, the elastomeric material deforms to allow the wipe to pass through, and then closes around the wipe to reduce evaporation (relative to a pouch that does not include the membrane as described herein). This can help keep the contents of the pouch moist and ready for use.

The single, unitary piece zipper closure can be repeatedly sealed shut and opened. This capability causes the pouch to be securely closed after each use, which also helps maintain the moisture of the wipes and prevents the wipes from prematurely drying out. Integration of the zipper closure with the membrane into a single unitary piece simplifies the manufacturing process and reduces potential points of failure where moisture could escape.

The connecting membrane extending between and joining the first and second interlocking profiles can include the dispensing aperture through which the wipes are extracted. This design allows for easy access to the wipes while maintaining the integrity of the seal when the pouch is closed. The connecting membrane's placement between the interlocking profiles can make the dispensing aperture centrally located. This allows for convenient and controlled dispensing of the wipes.

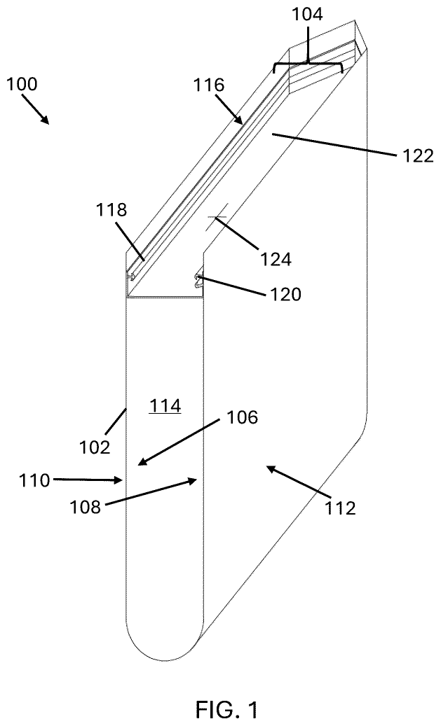

FIG. 1 illustrates one example of a wipes dispensing pouch assembly 100. The pouch assembly 100 includes a flexible pouch 102 having at least a first interior surface 106 and an opposing second interior surface 108, as well as a first exterior surface 110 and an opposite second exterior surface 112. Part of the pouch assembly 100 is removed in FIG. 1 to assist in visualizing the interior of the pouch assembly 100. The interior surfaces 106, 108 enclose or bound an interior enclosed volume 114 of the pouch 102. This volume 114 can retain or hold a plurality of moistened wipes therebetween. Optionally, the pouch assembly 100 may be formed from more than two interior surfaces 108, such as by the pouch assembly 100 having side gussets, having a cuboid shape, or the like. The exterior surfaces 110, 112 form the outer boundaries of the pouch assembly 100.

The flexible pouch 102 also includes a mouth 104 through which the interior volume 114 and the wipes are accessed. The pouch assembly 100 also includes a single, unitary piece zipper closure 116 coupled with the first interior surface 106 and the second interior surface 108. The zipper closure 116 includes opposing first and second interlocking profiles 118, 120. The first interlocking profile 118 and the second interlocking profile 120 can repeatedly mate with each other and separate from each other to repeatedly seal and open the pouch. In the illustrated example, the first interlocking profile 118 is an elongated projecting body with a bulbous head, and the second interlocking profile 120 is an elongated valley that can receive and secure the bulbous head of the first interlocking profile 118. Optionally, the zipper closure 116 may include more than one interlocking profile 118 or 120 on each side, or may include a combination of the interlocking profiles 118 and 120 on each side. The zipper closure 116 can seal the mouth 104 of the pouch assembly 100 to assist in keeping the wipes moist and protected from evaporation.

The zipper closure 116 further includes a connecting membrane 122 extending between and joining the first interlocking profile 118 and the second interlocking profile 120. The connecting membrane 122 has a dispensing aperture 124 through which the wipes are extracted from inside the pouch. The connecting membrane 122 serves as a bridge between the first interlocking profile 118 and the second interlocking profile 120, providing a continuous structure for the zipper closure 116. The dispensing aperture 124 in the connecting membrane 122 allows for the controlled extraction of wipes from the flexible pouch 102, ensuring ease of use and maintaining the moisture content of the wipes.

The single, unitary piece zipper closure 116 is coupled with the first interior surface 106 and the second interior surface 108 of the flexible pouch 102. The first interlocking profile 118 extends along the first interior surface 106, and the second interlocking profile 120 extends along the second interior surface 108. The connecting membrane 122 extends between the first interlocking profile 118 and the second interlocking profile 120 and between the first interior surface 106 and the second interior surface 108. This membrane 122 is securely attached to the flexible pouch 102 and provides a reliable sealing mechanism for the pouch 102. For example, the membrane 122 can be heat sealed or otherwise adhered to the interior surfaces 106, 108 of the pouch 102.

Forming the zipper closure 116 with both the interlocking profiles 118, 120 and the membrane 122 as a single, unitary body without any seams, interfaces, sealants, adhesion points or boundaries, welds, etc. can provide for improved sealing and retention of the moisture in the wipes (or other product) inside the interior volume 114. This can be improved over other pouches or enclosures having the membrane and interlocking profiles formed from separate bodies that are then sealed, adhered, welded, or the like, to each other as the locations of the seals, adhesions, welds, or the like, can provide weaker locations where moisture can escape.

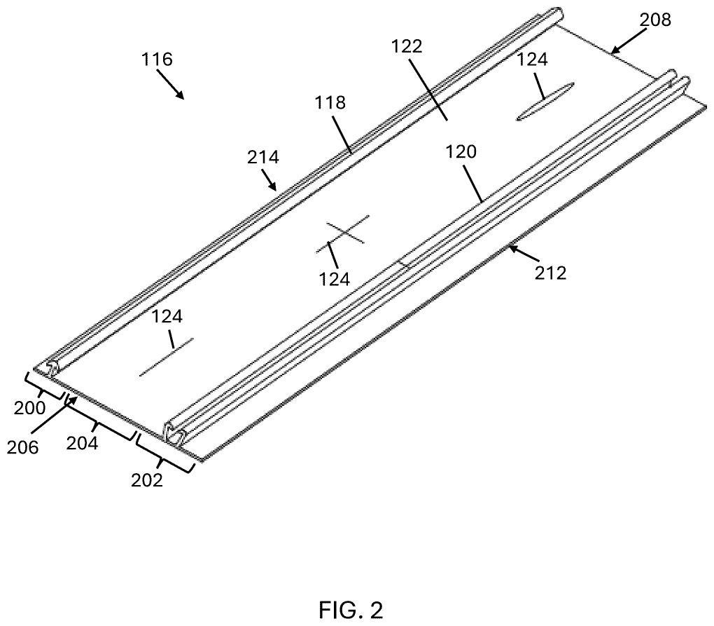

FIG. 2 illustrates one example of a zipper closure 116 of the pouch assembly 100 shown in FIG. 1. The zipper closure 116 can be formed (e.g., extruded) as a predominantly planar, elongated body. The zipper closure 116 can extend along a longer direction from a first end edge 206 to an opposite second end edge 208. The zipper closure 116 can extend along a shorter direction that is transverse (e.g., perpendicular) to the longer direction from a first side edge 212 to an opposite second side edge 214. The interlocking profiles 118, 120 project from a surface of the zipper closure 116 that can be referred to as a consumer-or customer-facing surface, as this surface faces away from the interior volume 114 of the pouch 102 and can face a consumer or user of the pouch assembly 100 when in use. The opposite surface of the zipper closure 116 can be referred to as a product-facing surface as this surface faces the interior volume 114 and away from the consumer or user of the pouch assembly 100 when in use. The product-facing surface can be a planar surface while the consumer-facing surface can be a predominantly planar surface with the interlocking profiles 118, 120 protruding up and away from the surface.

The zipper closure 116 can be treated as having different portions including a first coupling portion 200, a second coupling portion 202, and a bridging portion 204. These portions 200, 202, 204 may be different segments of the unitary body of the zipper closure 116 and not represent different sections that are fused, adhered, sealed, welded, or co-extruded together. The first coupling portion 200 extends along and is coupled with the first interior surface 106 of the pouch 102. The first interlocking profile 118 extends along and is located within this first coupling portion 200. The second coupling portion 202 extends along and is coupled with the second interior surface 108 of the pouch 102. The second interlocking profile 120 extends along and is located within this second coupling portion 202. The bridging portion 204 extends between the first and second coupling portions 200 and 202 and forms the connecting membrane 122 that includes the dispensing aperture 124. The body of the zipper closure 116 can be folded between the bridging portion 204 and each of the first coupling portion 200 and the second coupling portion 202. These folds can allow the interlocking profiles 118, 120 to face and mate with each other across the mouth 104 of the pouch 102.

Three different dispensing apertures 124 are shown in FIG. 2. One aperture 124 is a linear slit that is elongated in the longer direction of the zipper closure 116. Another aperture 124 is a cross slit that has the linear slit elongated in the longer direction and a shorter linear slit that is elongated in the shorter transverse direction of the zipper closure 116. Another aperture 124 is an oval opening that is elongated in the longer direction. Optionally, another aperture 124 may be used and/or the aperture 124 may be in a location that differs from those shown in FIG. 2. The zipper closure 116 may include a single aperture 124 or two or more apertures 124.

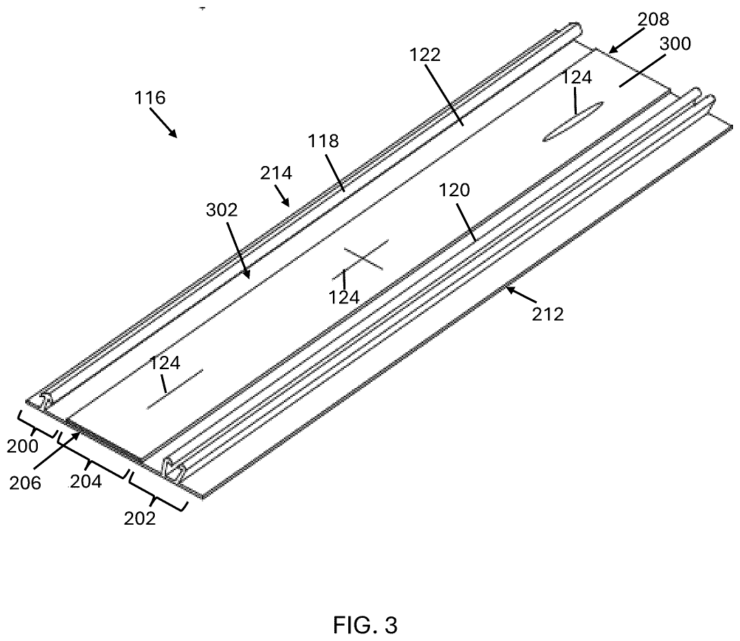

FIG. 3 illustrates another example of the zipper closure 116 shown in FIG. 1. The connecting membrane 122 may include an elastomeric layer 300 applied to the connecting membrane 122 between the first and second interlocking profiles 118 and 120. The elastomeric layer 300 can be applied as a coating over the connecting membrane 122. For example, the elastomeric layer 300 can be adhered, heat sealed, welded, etc. to a consumer-facing side 302 of the zipper closure 116. Optionally, the elastomeric layer 300 and the zipper closure 116 can be co-extruded together.

The elastomeric layer 300 can be formed from material(s) that stretch more than the material(s) forming the zipper closure 116. For example, the zipper closure 116 may be flexible, but may need to include some stiffness to allow the interlocking profiles 118, 120 to mate with each other to seal the mouth 104 of the pouch 102 closed. The elastomeric layer 300 can be made from materials with higher elasticity and lower density compared to the materials used for the zipper closure 116. For example, the elastomeric layer can be composed of thermoplastic elastomers (TPE), thermoplastic polyurethane (TPU), or ethylene-vinyl acetate (EVA), which have greater stretchability and flexibility than other polymers, such as low-density polyethylene (LDPE). The zipper closure 116 can be made from LDPE that provides sufficient rigidity and durability for the interlocking profiles 118, 120 but is less stretchy than the elastomeric materials forming the elastomeric layer 300.

During the co-extrusion process, the elastomeric layer 300 and the zipper closure 116 can be extruded simultaneously but with different material compositions. The elastomeric layer 300 can be extruded with a higher proportion of elastomeric polymers, resulting in a more stretchable and flexible layer. The zipper closure 116, on the other hand, can be extruded with a higher proportion of polyethylene to provide some rigidity for the interlocking profiles 118, 120. The thickness of the elastomeric layer 300 can be controlled to enhance stretchability. A thinner elastomeric layer 300 can provide greater flexibility and elasticity to allow the layer 300 to deform more easily when a wipe is pulled through the dispensing aperture 124. In contrast, the zipper closure 116 can have a greater thickness to maintain the structural integrity of the closure 116 and ensure reliable sealing by the interlocking profiles 118, 120.

The elastomeric layer 300 can be applied or co-extruded in specific regions of the connecting membrane 122 where higher stretchability is required. For example, the elastomeric layer 300 can be concentrated around the dispensing aperture 124, which can allow the aperture 124 to deform and stretch as wipes are pulled through, and then return to a prior shape. The rest of the connecting membrane 222 and the zipper closure 116 can remain less stretchy to provide stability and support. The elastomeric layer 300 can be created with additives or blended with other polymers to increase the elasticity of the layer 300. For example, plasticizers can be added to the elastomeric material to increase the flexibility and stretchability of the layer 300. The zipper closure 116 can be formulated without such additives to maintain rigidity and strength.

In one example, the elastomeric layer 300 may comprise or be formed from a stretchable plastic having a density of less than 0.900 g/cm³. In another example, the elastomeric layer 300 may comprise or be formed from a stretchable plastic having a density between 0.910 and 0.940 g/cm³, and so on. The elastomeric layer 300 on (or in, as described below) the connecting membrane 122 can provide a flexible interface between the zipper halves (e.g., the portions 200, 202 of the zipper closure 116). The elastomeric layer 300 can have elastic properties that can significantly stretch under stress and return to an original shape when the stress is removed (e.g., the elastomeric layer 300 can stretch a greater distance without permanent deformation relative to the material(s) used to fabricate the rest of the zipper closure 116). Examples of elastomeric plastics or materials that can be used to form the elastomeric layer 300 can include TPE, TPU, EVA, POE, silicone elastomers, SBS, or the like.

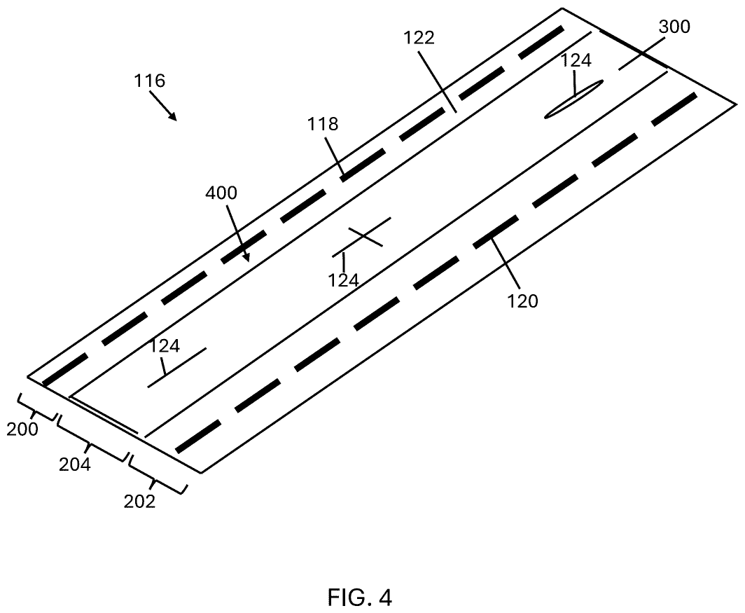

The elastomeric layer 300 and the connecting membrane 122 can be different portions of a co-extruded plastic body. The elastomeric layer 300 can be applied to the consumer-facing surface 302 of the connecting membrane 122, an opposite product-facing surface 400 of the connecting membrane 122 (shown in FIG. 4), or both. The elastomeric layer 300 can also be a first elastomeric layer applied to a consumer-facing surface 302 of the connecting membrane 122, and further include a second elastomeric layer applied to a product-facing surface 400 of the connecting membrane 122.

The elastomeric layer 300 can have the same or similar aperture(s) 124 as the connecting membrane 122. The apertures 124 in the elastomeric layer 300 and in the connecting membrane 122 may be aligned with each other so that the wipes can be pulled through the aligned apertures 124. The apertures 124 in the elastomeric layer 300 and in the connecting membrane 122 can be cut through both the elastomeric layer 300 and the connecting membrane 122 at the same time to ensure that the apertures 124 are aligned. Alternatively, the apertures 124 in the elastomeric layer 300 may be differently shaped and/or sized than the apertures 124 in the connecting membrane 122. This can assist with moisture retention. For example, the apertures 124 in the elastomeric layer 300 may be smaller than the apertures 124 in the connecting membrane 122.

FIG. 4 illustrates another example of the zipper closure 116 shown in FIG. 1. The connecting membrane 122 may include the elastomeric layer 300 applied to the connecting membrane 122 between the first and second interlocking profiles 118 and 120. Whereas the elastomeric layer 300 in the example shown in FIG. 3 is coupled or co-extruded onto the consumer-facing surface 302 of the zipper closure 116, the elastomeric layer 300 shown in FIG. 4 can be coupled or co-extruded onto the product-facing surface 400 of the zipper closure 116. The elastomeric layer 300 can be applied as a coating over the connecting membrane 122. For example, the elastomeric layer 300 can be adhered, heat sealed, welded, etc. to the product-facing side 400 of the zipper closure 116. Optionally, the elastomeric layer 300 and the zipper closure 116 can be co-extruded together.

In another example, the elastomeric layer 300 may include multiple layers 300, with one layer 300 coupled to or co-extruded onto the product-facing surface 400 of the membrane 122 of the zipper closure 116 and another layer 300 coupled to or co-extruded onto the consumer-facing surface 302 of the membrane 122 of the zipper closure 116.

The elastomeric layer 300 may be on the consumer-facing side 302 of the membrane 122 to improve the consumer experience by offering a more tactile and flexible interface. This positioning allows the elastomeric material in the layer 300 to deform more easily when a wipe is pulled through the dispensing aperture 124. This can provide a smoother and more controlled dispensing process. The elasticity of the material in the layer 300 can help the membrane 122 to stretch and accommodate the wipe as the wipe is being extracted, and then return to the original shape of the membrane 122, effectively sealing the aperture 124 and reducing moisture loss.

Additionally, placing the elastomeric layer 300 on the consumer-facing side 302 of the membrane 122 can protect the layer 300 from direct contact with the product inside the pouch 102. The product (e.g., moistened wipes) may contain moisture or other substances that could potentially degrade the elastomeric material in the layer 300 over time. This positioning can prolong the durability and functionality of the elastomeric layer 300 to provide consistent performance throughout the lifespan of the pouch 102 and pouch assembly 100. The consumer-facing side 302 may be less likely to be exposed to the internal environment of the pouch 102, which can include moisture, oils, or other substances that could affect the integrity of the elastomeric material in the layer 300.

Furthermore, the consumer-facing elastomeric layer 300 can provide a more aesthetically pleasing appearance and a better grip for the user. The tactile properties of the elastomeric material in the layer 300 can improve the user's ability to handle and manipulate the pouch assembly 100, making the pouch assembly 100 easier to open and close the zipper closure 116. This can improve the overall user experience by providing a more reliable and user-friendly interface for accessing the wipes. The flexibility and resilience of the layer 300 on the consumer-facing side 302 can contribute to a more effective and durable sealing mechanism, ensuring that the wipes remain moist and ready for use.

Conversely, the elastomeric layer 300 can be applied to the product-facing side 400 of the membrane 122 to improve the sealing properties and moisture retention of the wipes dispensing pouch 102. By positioning the elastomeric layer 300 on the product-facing side 400, the layer 300 can directly interact with the wipes and the internal environment of the pouch 102. This placement can allow the elastomeric material in the layer 300 to deform and stretch as wipes are pulled through the dispensing aperture 124 to provide a tight seal around the wipes and reduce the potential for moisture loss. The ability of the layer 300 to return to the original shape after deformation helps maintain the integrity of the seal, keeping the wipes moist and ready for use.

Additionally, placing the elastomeric layer 300 on the product-facing side 400 can protect the layer 300 from external factors that may degrade the performance over time. The internal environment of the pouch 102, which includes the wipes and their moisture content, can include materials that may benefit from the direct contact with the elastomeric material in the layer 300. This positioning can prolong the durability and functionality of the elastomeric layer 300 and ensure consistent performance throughout the lifespan of the pouch 102. The product-facing surface 400 may be less likely to be exposed to external elements that could affect the integrity of the elastomeric material in the layer 300, such as handling by consumers or environmental conditions.

Furthermore, the product-facing elastomeric layer 300 can provide a more effective and durable sealing mechanism. The elasticity of the material in the layer 300 allows the membrane 122 to stretch and accommodate the wipe as the wipe is being extracted, and then return to the original shape of the membrane 122, effectively sealing the aperture 124 and reducing moisture loss. This positioning can contribute to a more reliable and user-friendly interface for accessing the wipes to make sure that the wipes remain moist and ready for use. The flexibility and resilience of the elastomeric layer 300 on the product-facing surface 400 can enhance the overall functionality and moisture retention of the pouch 102.

Optionally, multiple layers 300 may be provided with at least one layer 300 on each of the surfaces 302, 400. This can provide the benefits of the layer 300 on each of the surfaces 302, 400 described above.

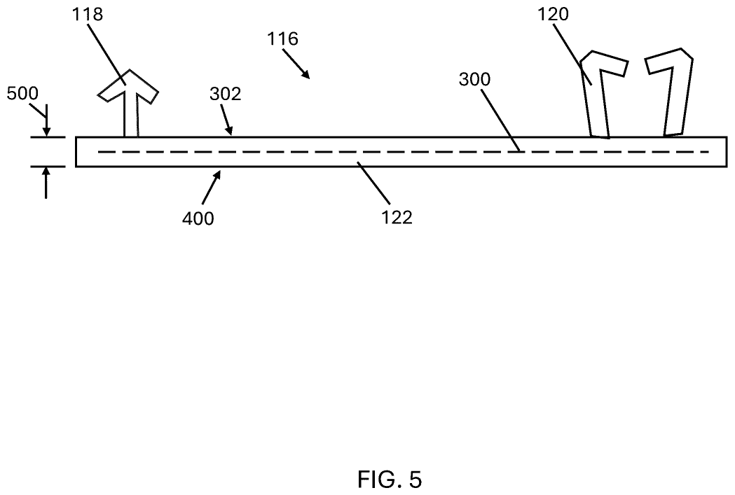

FIG. 5 illustrates another example of the zipper closure 116 shown in FIG. 1. In addition to, or in place of, the elastomeric layer 300 being on the product-facing side 400 and/or the consumer-facing side 302 of the connecting membrane 122, the elastomeric layer 300 may be positioned within a thickness 500 of the membrane 122. This thickness 500 can extend from and be defined by the distance from one surface or side 302 or 400 to the opposite surface or side 400 or 302. The elastomeric layer 300 may be co-extruded with the material of the zipper closure 116 so that the layer 300 is completely embedded within the thickness 500 of the membrane 122 with no portion of the layer 300 exposed.

The elastomeric layer 300 can be positioned within the thickness 500 of the membrane 122, rather than on the outer surfaces 302, 400, to provide functional benefits. Embedding the elastomeric layer 300 within the thickness 500 of the membrane 122 can increase the structural integrity of the membrane 122 by distributing the elastomeric material in the layer 300 within the body of the membrane 122. This can prevent the elastomeric layer 300 from being exposed to external factors that could degrade the performance of the elastomeric layer 300 over time, such as handling by consumers, environmental conditions, and/or exposure to the materials within the pouch 102. By being embedded, the elastomeric layer 300 can maintain the elasticity and functionality of the elastomeric layer 300 without being directly subjected to wear and tear or potential damage from external elements.

Additionally, placing the elastomeric layer 300 within the thickness 500 of the membrane 122 can improve the sealing properties and moisture retention of the wipes dispensing pouch 102. This placement can enable the elastomeric material of the layer 300 to deform and stretch as wipes are pulled through the dispensing aperture 124 to provide a tight seal around the wipes and reducing the potential for moisture loss.

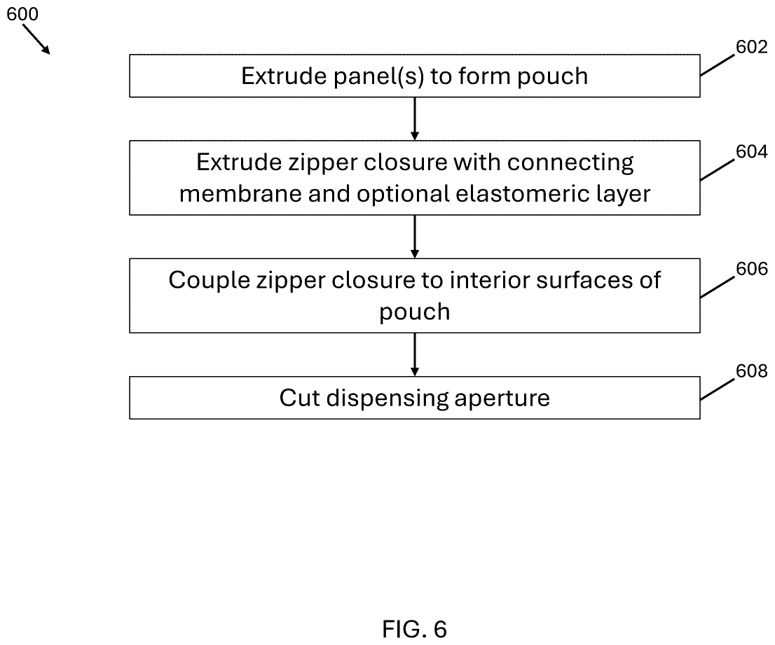

FIG. 6 illustrates a flowchart of one example of a method 600 for manufacturing a wipes dispensing pouch assembly. The method 600 can be used to create one or more examples of the pouch assembly 100 described herein. At 602, panels forming the pouch 102 are extruded. For example, the pouch without the zipper closure 116 can be formed from one or more sheets of plastic material. A single sheet can be extruded, folded over, and then sealed along opposite sides to form the pouch 102 with the open mouth 104. Optionally, multiple sheets of plastic material may be sealed together along several edges while leaving one edge open to form the pouch 102 with the mouth 104.

At 604, a zipper closure is extruded. The zipper closure 116 may be extruded to include the connecting membrane 122 and the interlocking profiles 118, 120, as described above. Optionally, the zipper closure may be extruded with an elastomeric layer. For example, the zipper closure 116 and the elastomeric layer 300 may be co-extruded together. A single or multiple layers 300 may be co-extruded with the zipper closure 116, as described herein. At 606, the zipper closure is coupled with interior surfaces of the pouch. For example, the portions 200, 202 of the zipper closure 116 can be heat sealed, welded, adhered, or otherwise affixed to the interior surfaces 106, 108 of the pouch 102 at or near the mouth 104 of the pouch 102.

At 608, one or more dispensing apertures are cut. The dispensing apertures 124 can be cut through the membrane 122 of the zipper closure 116 and the elastomeric layer(s) 300 if present. Optionally, the dispensing apertures 124 may be cut or formed prior to coupling the zipper closure 116 to the pouch 102.

Examples of the subject matter described herein provide a wipes dispensing pouch assembly having a flexible pouch with opposing first and second interior surfaces that can retain a plurality of moistened wipes between the interior surfaces, and a single, unitary piece zipper closure coupled with the first and second interior surfaces of the flexible pouch. The zipper closure includes opposing first and second interlocking profiles that can repeatedly mate with each other and separate from each other to repeatedly seal and open the pouch, and a connecting membrane extending between and joining the first and second interlocking profiles. The connecting membrane has a dispensing aperture through which the wipes are extracted from inside the pouch. The single, unitary piece zipper closure is coupled with the first and second interior surfaces of the pouch with the first interlocking profile extending along the first interior surface, the second interlocking profile extending along the second interior surface, and the connecting membrane extending between the first and second interlocking profiles and between the first and second interior surfaces.

In at least one example, the pouch assembly further comprises an elastomeric layer applied to or located within the connecting membrane between the first and second interlocking members. The elastomeric layer can include a stretchable plastic having a density of less than 0.900 g/cm³. The elastomeric layer can elastically deform to allow the wipes to be pulled through the dispensing aperture and to close around the dispensing aperture to reduce or eliminate evaporation of liquid content within the pouch.

The elastomeric layer and the connecting membrane can be different portions of a co-extruded plastic body. The elastomeric layer can be applied as a coating over the connecting membrane. In at least one example, the elastomeric layer is applied as a layer enclosed within a thickness of the connecting membrane between a consumer-facing surface and an opposite product-facing surface of the connecting membrane. In at least one example, the elastomeric layer is applied to a product-facing surface of the connecting membrane.

In at least one example, the elastomeric layer is applied to a consumer-facing surface of the connecting membrane. In at least one example, the elastomeric layer is a first elastomeric layer applied to a consumer-facing surface of the connecting membrane, and further comprises a second elastomeric layer applied to a product-facing surface of the connecting membrane. In at least one example, the zipper closure is made from low-density polyethylene. In at least one example, the connecting membrane comprises a slit as the dispensing aperture. In at least one example, the connecting membrane comprises a cross arrangement of slits as the dispensing aperture.

Other examples of the subject matter described herein provide a method for manufacturing a wipes dispensing pouch assembly. The method comprises extruding one or more panels that form a flexible pouch, the one or more panels extruded to have opposing first and second interior surfaces in the flexible pouch that are shaped to retain a plurality of moistened wipes between the interior surfaces; extruding a single, unitary piece zipper closure having opposing first and second interlocking profiles shaped to repeatedly mate with each other and separate from each other to repeatedly seal and open the pouch, the zipper closure also extruded to have a connecting membrane extending between and joining the first and second interlocking profiles; coupling the zipper closure to the first and second interior surfaces of the one or more panels with the first interlocking profile extending along the first interior surface and the second interlocking profile extending along the second interior surface and the connecting membrane bridging a gap between the first and second interior surfaces; and cutting a dispensing aperture through the connecting membrane through which the wipes are extracted from inside the pouch.

In at least one example, the method further comprises co-extruding an elastomeric layer with the zipper closure onto or inside the connecting membrane between the first and second interlocking members. In at least one example, the elastomeric layer is co-extruded onto the connecting membrane as a coating over the connecting membrane. In at least one example, the elastomeric layer is co-extruded into the connecting member as a layer enclosed within a thickness of the connecting membrane between a consumer-facing surface and an opposite product-facing surface of the connecting membrane.

Examples of the subject matter described herein provide a wipes dispensing pouch assembly having a flexible pouch with opposing first and second interior surfaces configured to retain a plurality of moistened wipes between the interior surfaces, a zipper closure coupled with the first and second interior surfaces of the flexible pouch, the zipper closure comprising first and second interlocking profiles configured to mate with each other to seal the pouch, the zipper closure also including a membrane extending between and joining the first and second interlocking profiles, the membrane having a dispensing aperture through which the wipes are removed from the pouch, and an elastomeric layer applied to or located within the membrane between the first and second interlocking members.

In at least one example, the elastomeric layer is a first coating on a consumer-facing surface of the membrane, is a second coating on a product-facing surface of the membrane, or is both the first coating and the second coating. In at least one example, the elastomeric layer is enclosed within a thickness of the membrane.

The singular forms “a,” “an,” and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A wipes dispensing pouch assembly comprising:
a flexible pouch defining an interior volume bounded at least in part by opposing first and second interior surfaces and configured to retain a plurality of moistened wipes within the interior volume; and
a zipper closure formed as a single, unitary, and co-extruded body that is coupled to the opposing first and second interior surfaces, the zipper closure comprising opposing first and second interlocking profiles configured to repeatedly mate with and separate from each other to selectively seal and open the pouch, and a connecting membrane co-extruded with and extending between the first and second interlocking profiles and spanning between the opposing first and second interior surfaces, the connecting membrane having a dispensing aperture through which an individual wipe of the moistened wipes is extracted, the connecting membrane including an elastomeric layer located between the first and second interlocking profiles, the elastomeric layer configured to elastically deform to permit passage of the individual wipe through the dispensing aperture and to resiliently return toward a closed condition around the dispensing aperture after the passage to reduce evaporation of liquid from the interior volume.

2. The pouch assembly of claim 1, wherein the zipper closure is devoid of gaps, devoid of adhesive, and devoid of seams.

3. The pouch assembly of claim 1, wherein the elastomeric layer comprises a stretchable plastic having a density of less than 0.900 grams per cubic centimeter (g/cm3).

4. The pouch assembly of claim 1, wherein the elastomeric layer and the connecting membrane are different portions of a co-extruded plastic body.

5. The wipes dispensing pouch of claim 1, wherein the elastomeric layer is a coating over the connecting membrane.

6. The wipes dispensing pouch of claim 1, wherein the elastomeric layer is applied as a layer enclosed within a thickness of the connecting membrane between a consumer-facing surface and an opposite product-facing surface of the connecting membrane.

7. The wipes dispensing pouch of claim 1, wherein the elastomeric layer is applied to a product-facing surface of the connecting membrane.

8. The wipes dispensing pouch of claim 1, wherein the elastomeric layer is applied to a consumer-facing surface of the connecting membrane.

9. The wipes dispensing pouch of claim 1, wherein the elastomeric layer is a first elastomeric layer applied to a consumer-facing surface of the connecting membrane, and further comprising a second elastomeric layer applied to a product-facing surface of the connecting membrane.

10. The wipes dispensing pouch of claim 1, wherein the zipper closure is made from low-density polyethylene.

11. The wipes dispensing pouch of claim 1, wherein the connecting membrane comprises a slit as the dispensing aperture.

12. The wipes dispensing pouch of claim 1, wherein the connecting membrane comprises a cross arrangement of slits as the dispensing aperture.

13. A method of manufacturing a wipes dispensing pouch assembly, the method comprising:
co-extruding a zipper closure as a unitary body, the zipper closure including opposing first and second interlocking profiles and a connecting membrane extending between and joining the first and second interlocking profiles;
during co-extruding the zipper closure, co-extruding an elastomeric layer in or on the connecting membrane between the first and second interlocking profiles, the elastomeric layer being configured to elastically deform to permit passage of a wipe through a dispensing aperture and to resiliently return toward a closed condition to reduce evaporation from within the pouch; coupling the zipper closure to opposing first and second interior surfaces of a flexible pouch such that the first interlocking profile extends along the first interior surface, the second interlocking profile extends along the second interior surface, and the connecting membrane spans between the first and second interior surfaces; and
forming the dispensing aperture through the connecting membrane through which the wipes are extracted from inside the pouch.

14. The method of claim 13, wherein the elastomeric layer is co-extruded onto the connecting membrane as a coating over the connecting membrane.

15. The method of claim 13, wherein the elastomeric layer is co-extruded into the connecting membrane as a layer enclosed within a thickness of the connecting membrane between a consumer-facing surface and an opposite product-facing surface of the connecting membrane.

16. The method of claim 13, wherein forming the dispensing aperture comprises cutting a cross arrangement of slits through the connecting membrane.

17. The method of claim 13, wherein co-extruding the elastomeric layer comprises co-extruding a stretchable plastic having a density of less than 0.900 grams per cubic centimeter.

18. A wipes dispensing pouch assembly comprising:
a flexible pouch having opposing first and second interior surfaces configured to retain a plurality of moistened wipes between the interior surfaces;
a zipper closure coupled with the first and second interior surfaces of the flexible pouch, the zipper closure comprising first and second interlocking profiles configured to mate with each other to seal the pouch, the zipper closure also including a membrane extending between and joining the first and second interlocking profiles, the membrane having a dispensing aperture through which the wipes are removed from the pouch; and
an elastomeric layer applied to or located within the membrane between the first and second interlocking profiles.

19. The pouch assembly of claim 18, wherein the elastomeric layer is a first coating on a consumer-facing surface of the membrane, is a second coating on a product-facing surface of the membrane, or is both the first coating and the second coating.

20. The pouch assembly of claim 18, wherein the elastomeric layer is enclosed within a thickness of the membrane.
